(19) United States
(12) Patent Application Publication
(10) Pub. No.: US 2026/0036489 A1
(43) Pub. Date: Feb. 5, 2026

(54) DIFFERENTIAL MODE DELAY MEASURING DEVICE AND METHOD

(71) Applicant: NIPPON TELEGRAPH AND TELEPHONE CORPORATION, Tokyo (JP)

(72) Inventors: Tomokazu ODA, Musashino-shi, Tokyo (JP); Hiroshi TAKAHASHI, Musashino-shi, Tokyo (JP); Atsushi NAKAMURA, Musashino-shi, Tokyo (JP); Yusuke KOSHIKIYA, Musashino-shi, Tokyo (JP)

(73) Assignee: NIPPON TELEGRAPH AND TELEPHONE CORPORATION, Tokyo (JP)

(21) Appl. No.: 18/997,435

(22) PCT Filed: Jul. 29, 2022
(86) PCT No.: PCT/JP2022/029324

§ 371 Date: Jan. 21, 2025

(51) Int. Cl. G01M 11/00; G01D 5/353

(52) U.S. Cl. CPC G01M 11/331; G01D 5/35335

(57) ABSTRACT

An object is to provide a differential mode delay measurement device and a method thereof capable of measuring a DMD with a simple configuration even when an FMF to be measured is a long distance.

A differential mode delay measurement device 301 according to the present invention includes a light source 11 configured to output a coherent light beam having an optical frequency changed with a predetermined modulation period, a branching element 12 configured to bifurcate the light beam; a light incidence unit 13 configured to excite one of the light beams in a plurality of modes, cause the one of the light beams to enter one end of an optical fiber to be measured 51 that is a few-mode optical fiber, and input the other of the light beams into one end of a reference optical fiber 52 in a single mode; an image sensor 15 configured to observe an interference light beam between a measurement light beam emitted from the other end of the optical fiber to be measured 51 and a reference light beam emitted from the other end of the reference optical fiber 52; and an arithmetic unit 16 configured to detect a peak of the interference light beam appearing when the modulation period is changed, and measure a differential mode delay based on a period of the peak and an electric field distribution of the interference light beam at the peak.

### TECHNICAL FIELD

The present disclosure relates to a device and a method for measuring a differential mode delay (DMD) of a few-mode fiber.

### BACKGROUND ART

A few-mode fiber (FMF) is one of promising optical fibers as a medium for realizing future large-capacity optical communication. In the FMF, transmission is performed using a plurality of modes as independent transmission paths, but crosstalk occurs where signals of the modes are mixed during propagation, and thus signal processing for compensating for the crosstalk is required on a reception side. There is a problem that, if a group delay time of each mode is different, that is, if the differential mode delay (DMD) is large when compensating for the crosstalk using the signal processing on the reception side of the FMF, the crosstalk cannot be compensated for. Therefore, the DMD of the FMF is an important parameter in the signal processing, and a method for measuring the DMD is required.

In the DMD measurement, it is desirable to be able to determine an arrival time of a light beam after FMF emission and the mode of the arrived light beam. Therefore, the method of Non Patent Literature 1 is proposed in order to grasp an arrival time and an arrival mode. The method of Non Patent Literature 1 uses a wavelength-tunable light source and an image sensor. An interference pattern between the modes observed after FMF emission changes due to a delay time difference between the modes. Specifically, intensity of an emitted light beam becomes periodic with respect to a wavelength due to the interference between the modes, but the period changes due to the delay time difference. In the method of Non Patent Literature 1, a delay time of each mode is acquired from an observed period and an electric field intensity distribution thereof.

Further, the method disclosed in Non Patent Literature 2 uses a low-coherence light source and an image sensor. An interference light beam between an FMF emission light beam and a reference light beam passing through a single mode fiber (SMF) is observed by the image sensor. In the method of Non Patent Literature 2, the group delay time of each mode is measured by measuring the interference light beam while changing a length of a reference path, using a feature that the intensity of the interference light beam increases in a case where a specific mode of each mode of the FMF is the same in length as a basic mode of the SMF.

### CITATION LIST

### Non Patent Literature

Non Patent Literature 1: David R. Gray et al., “Real-Time Modal Analysis via Wavelength-Swept Spatial and Spectral (S2) Imaging”, IEEE Photon. Technol. Lett. 28 (9), 1034-1037 (2016).
Non Patent Literature 2: Y. Abe et al., “Collective measurement of DMD in 6-mode 19-core fiber using low-coherence digital holography”, Proc. SPIE 11309, 1130904, (2020).

### SUMMARY OF INVENTION

### Technical Problem

However, the method of Non Patent Literature 1 has a problem that it is difficult to measure the DMD when the FMF is several hundred meters or more because the period of the interference pattern increases as the delay time difference increases.

Further, the method of Non Patent Literature 2 has a problem that it is difficult to perform measurement with a simple configuration because it is necessary to perform measurement while changing the length of the reference path, and it is necessary to significantly change the length of the reference path, particularly when the DMD is large.

Therefore, to solve the above problems, an object of the present invention is to provide a differential mode delay measurement device and a method thereof capable of measuring a DMD with a simple configuration even when an FMF to be measured is a long distance.

### Solution to Problem

To achieve the above object, the differential mode delay measurement device according to the present invention measures an interference waveform of a light beam in which an optical frequency is periodically changed by an image sensor.

Specifically, a differential mode delay measurement device according to the present invention includes:
a light source configured to output a coherent light beam having an optical frequency changed with a predetermined modulation period;
a branching element configured to bifurcate the light beam;
a light incidence unit configured to excite one of the light beams in a plurality of modes, cause the one of the light beams to enter one end of an optical fiber to be measured that is a few-mode optical fiber, and input the other of the light beams into one end of a reference optical fiber in a single mode;
an image sensor configured to observe an interference light beam between a measurement light beam emitted from the other end of the optical fiber to be measured and a reference light beam emitted from the other end of the reference optical fiber; and
an arithmetic unit configured to detect a peak of the interference light beam appearing when the modulation period is changed, measure a group delay difference based on a difference in the modulation period in which the peak appears, and determine a type of the mode from an electric field distribution of the interference light beam at the peak.

Further, a differential mode delay measuring method according to the present invention includes:
setting a modulation period for changing an optical frequency of a coherent light beam;
bifurcating the light beam;
exciting one of the light beams in a plurality of modes, causing the one of the light beams to enter one end of an optical fiber to be measured that is a few-mode optical fiber, and inputting the other of the light beams into one end of a reference optical fiber in a single mode;
observing, by an image sensor, an interference light beam between a measurement light beam emitted from the other end of the optical fiber to be measured and a reference light beam emitted from the other end of the reference optical fiber; and
detecting a peak of the interference light beam appearing when the modulation period is changed, measuring a group delay difference based on a difference in the modulation period in which the peak appears, and measuring a type of the mode from an electric field distribution of the interference light beam at the peak.

The present differential mode delay measurement device and method have a simple configuration to change the optical frequency of the coherent light beam, prepare one reference optical fiber arranged in parallel with the optical fiber to be measured, and observe, by the image sensor, the interference light beam obtained by causing light beams passing through the optical fiber to be measured and the reference optical fiber to interfere with each other.

In the present configuration, by changing the modulation period for changing the optical frequency, the peak of the interference light beam observed by the image sensor appears with a time shift for each mode. In addition, since the electric field distribution at the peak of the interference light beam can be obtained by the image sensor, it is possible to determine which mode each peak belongs to. Therefore, the time between the peaks can be defined as a DMD.

Since the present differential mode delay measurement device and method measure the time between the peaks, it is possible to measure the DMD without replacing the reference optical fiber even if the FMF has a length of several hundred meters or more, the delay time difference is large, and the period of an interference pattern becomes large.

Therefore, the present invention can provide a differential mode delay measurement device and a method thereof capable of measuring a DMD with a simple configuration even when an FMF to be measured is a long distance.

Note that the arithmetic unit can also be implemented by a computer and a program, and the program can be recorded in a recording medium or provided through a network.

Further, the above-described inventions can be combined as much as possible.

### Advantageous Effects of Invention

The present invention can provide a differential mode delay measurement device and a method thereof capable of measuring a DMD with a simple configuration even when an FMF to be measured is a long distance.

### BRIEF DESCRIPTION OF DRAWINGS

FIG. 1 is a diagram for describing a differential mode delay measurement device according to the present invention.

FIG. 2 is a diagram for describing a light beam output from a light source of the differential mode delay measurement device according to the present invention.

FIG. 3 is a diagram for describing a measurement principle of the differential mode delay measurement device according to the present invention.

FIG. 4 is a diagram for describing a measurement principle of the differential mode delay measurement device according to the present invention.

FIG. 5 is a diagram for describing a measurement principle of the differential mode delay measurement device according to the present invention.

FIG. 6 is a diagram for describing a measurement principle of the differential mode delay measurement device according to the present invention.

FIG. 7 is a diagram for describing a differential mode delay measuring method according to the present invention.

### DESCRIPTION OF EMBODIMENTS

Embodiments of the present invention will be described with reference to the accompanying drawings. The embodiments to be described below are examples of the present invention, and the present invention is not limited to the embodiments to be described below. It is assumed that components denoted by the same reference numerals in the present specification and the drawings are the same components.

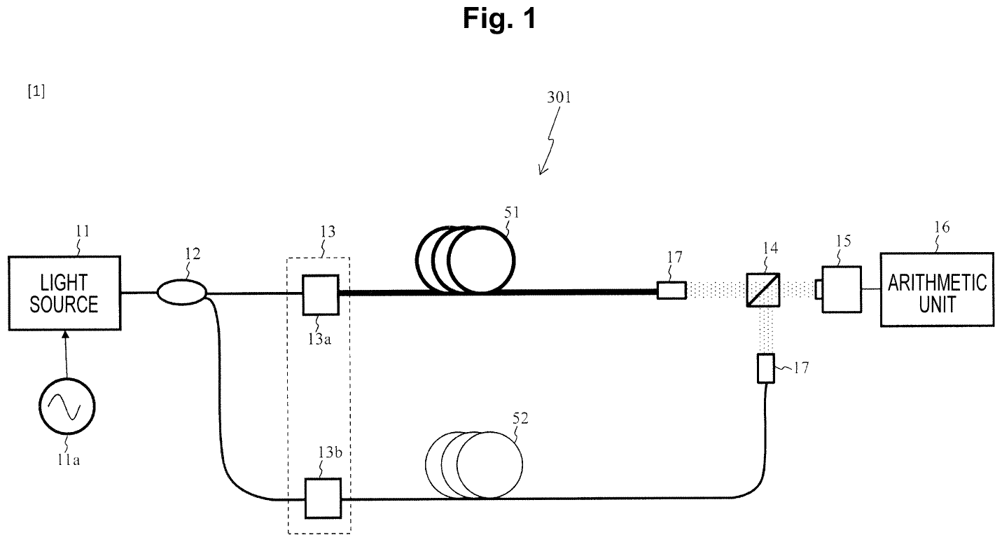

FIG. 1 is a diagram for describing a differential mode delay measurement device 301 according to the present embodiment. The differential mode delay measurement device 301 includes:
a light source 11 configured to output a coherent light beam having an optical frequency changed with a predetermined modulation period;
a branching element 12 configured to bifurcate the light beam;
a light incidence unit 13 configured to excite one of the light beams in a plurality of modes, cause the one of the light beams to enter one end of an optical fiber to be measured 51 that is a few-mode optical fiber, and input the other of the light beams into one end of a reference optical fiber 52 in a single mode;
an image sensor 15 configured to observe an interference light beam between a measurement light beam emitted from the other end of the optical fiber to be measured 51 and a reference light beam emitted from the other end of the reference optical fiber 52; and
an arithmetic unit 16 configured to detect a peak of the interference light beam appearing when the modulation period is changed, measure a group delay difference based on a difference in the modulation period in which the peak appears, and determine a type of the mode from an electric field distribution of the interference light beam at the peak.

The optical fiber to be measured 51 is an FMF. The reference optical fiber 52 is an SMF.

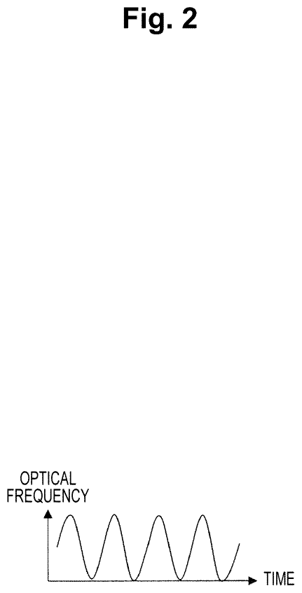

The light source 11 outputs a coherent light beam whose optical frequency periodically changes as illustrated in FIG. 2. A modulator 11a can adjust a period (modulation frequency) in which the optical frequency changes. The branching element 12 bifurcates the light beam output from the light source 11. The light incidence unit 13 excites one of the bifurcated light beams in a plurality of modes by an exciter 13a and then causes the one light beam to enter the optical fiber to be measured 51. Further, the light incidence unit 13 causes the other of the bifurcated light beams to enter the reference optical fiber 52 by a light incidence means 13b.

The light beams propagated through the respective optical fibers (51 and 52) are spatially output by a collimator 17. A multiplexing element 14 multiplexes both the light beams to interfere with each other to obtain the interference light beam. The image sensor 15 measures an electric field intensity distribution of the interference light beam. The arithmetic unit 16 analyzes a DMD from a measurement result of the interference light beam.

That is, the differential mode delay measurement device 301 is characterized in measuring the interference light beam of the light beam in which the optical frequency is periodically modulated by the image sensor, and measuring the DMD from a change in the electric field intensity distribution thereof.

The period (modulation frequency) in which the optical frequency of the light beam output by the light source 11 changes is variable. The differential mode delay measurement device 301 measures the DMD by changing the modulation frequency.

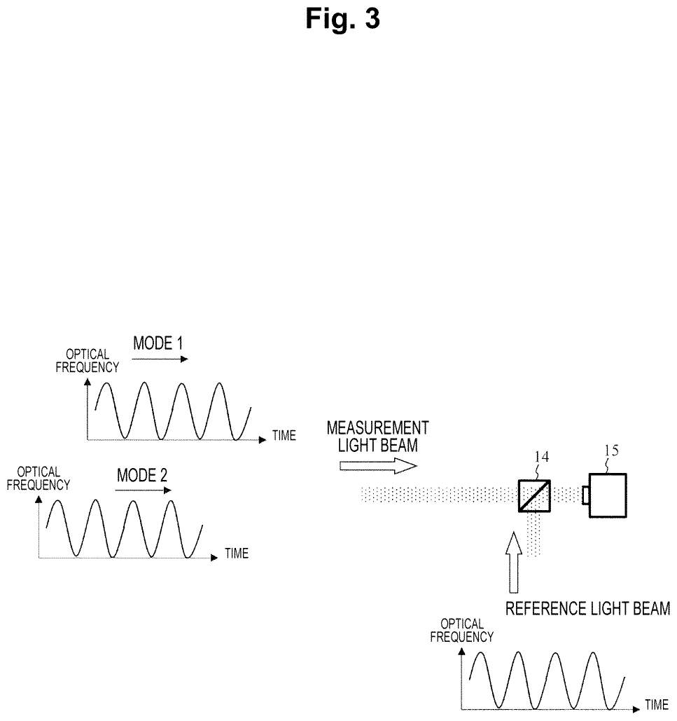

FIGS. 3 to 6 are diagrams for describing a measurement principle capable of measuring the DMD from the change in the electric field intensity distribution of the interference light beam. In FIGS. 3 to 6, a case where the optical fiber to be measured 51 is a two-mode optical fiber will be described for simplicity, but the same similarly applies to a case where the optical fiber to be measured 51 is an optical fiber capable of performing propagation in three or more modes.

FIG. 3 is a diagram for describing a process of measuring the interference light beam obtained by causing the measurement light beam and the reference light beam to interfere with each other.

The measurement light beam emitted from the optical fiber to be measured 51 is a light beam in mode 1 and a light beam in mode 2 propagating slower than the mode 1. Meanwhile, the light beam emitted from the reference optical fiber 52 is the reference light beam. The multiplexing element 14 multiplexes the measurement light beams in the mode 1 and in the mode 2 and the reference light beam, and the image sensor 15 measures the interference light beam.

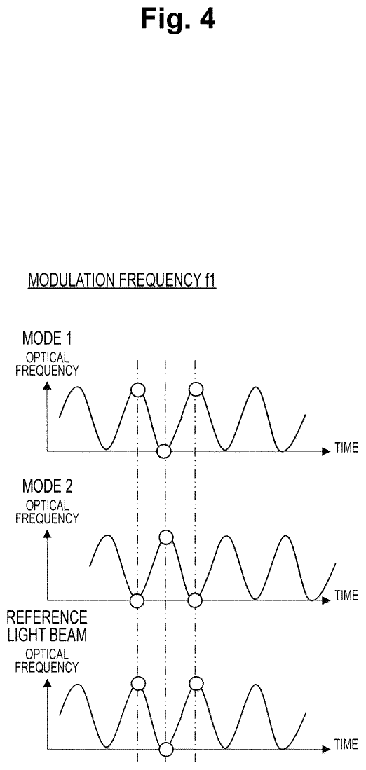

FIG. 4 is a diagram illustrating timing of the optical frequency of each light beam at the time of multiplexing the measurement light beam and the reference light beam when the modulation frequency is f1.

It is assumed that, when the modulation frequency of the light source 11 is set to f1, phases of the light beam in the mode 1 and the reference light beam coincide with each other. In this case, an interference waveform between the light beam in the mode 1 and the reference light beam becomes a DC component. Meanwhile, since the phases of the light beam in the mode 2 and the reference light beam do not coincide with each other, the interference waveform temporally varies according to an optical frequency difference (phase difference).

The image sensor 15 operates at a sampling rate slower than the modulation frequency.

Since the image sensor 15 generally has a low sampling rate (frame rate), it is difficult to observe a component (the interference waveform of the light beam in the mode 2 and the reference light beam) that varies due to the phase difference. Meanwhile, the image sensor 15 can measure the DC component (the interference waveform of the light beam in the mode 1 and the reference light beam). Therefore, the image sensor 15 can observe only the electric field distribution of the light beam in the mode 1 that becomes the DC component by performing measurement with a sufficient exposure time (averaging time). That is, when the modulator 11a sets the modulation frequency f1, the image sensor 15 measures the electric field distribution of the light beam in the mode 1.

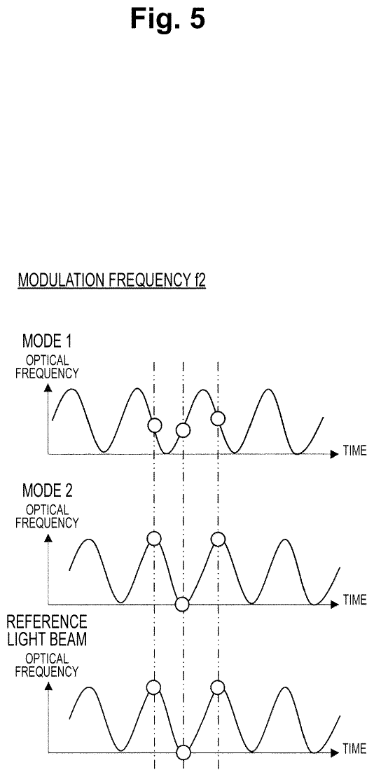

FIG. 5 is a diagram illustrating timing of the optical frequency of each light beam at the time of multiplexing the measurement light beam and the reference light beam when the modulation frequency is f2.

It is assumed that, when the modulation frequency of the light source 11 is set to f2, the phases of the light beam in the mode 2 and the reference light beam coincide with each other. In this case, the interference waveform between the light beam in the mode 2 and the reference light beam becomes a DC component. Meanwhile, since the phases of the light beam in the mode 1 and the reference light beam do not coincide with each other, the interference waveform temporally varies according to the optical frequency difference (phase difference).

As described above, since the image sensor 15 has a low sampling rate (frame rate), when the modulator 11a sets the modulation frequency f2, the image sensor 15 measures the electric field distribution of the light beam in the mode 2.

The optical frequency f (t) of the light beam output from the light source 11 changes with time t as in the following expression (see FIG. 2).

$$[ Math . 1 ]$$

$$f ( t ) = {f}_{0} + Δ f sin ( 2 π {f}_{m} t ) \qquad ( 1 )$$

f₀ is a center frequency, Δf is modulation amplitude, fₘ is the modulation frequency, and t is a time.

Here, a relationship between fₘ and t will be described. When an effective refractive index of the optical fiber to be measured 51 is n, a speed of the light beam in vacuum is c, and a difference ΔL in length between the optical fiber to be measured 51 and the reference optical fiber 52 is a length between the length of N periods of fₘ and the length of (N+1) periods, that is, the expression (2) below is satisfied, the relationship between fₘ and t satisfy the expression (3) below.

$$[ Math . 2 ]$$

$$\frac{Nc}{{nf}_{m}} < Δ L < \frac{( N + 1 ) c}{{nf}_{m}} \qquad ( 2 )$$

$$[ Math . 3 ]$$

$$t ∝ \frac{1}{{Nf}_{m}} \qquad ( 3 )$$

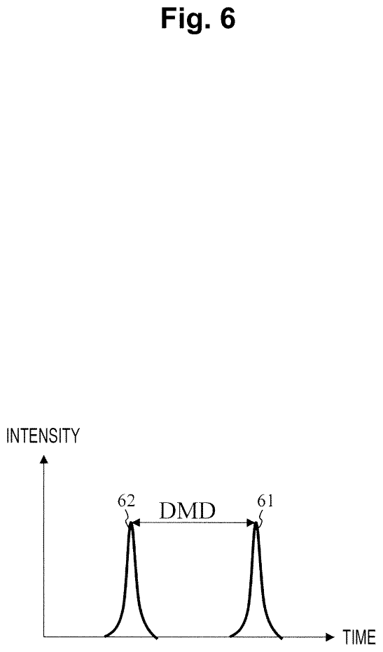

According to this relationship, intensity of the interference waveform with respect to the time as illustrated in FIG. 6 can be obtained by measuring the interference waveform by the image sensor 15 while changing the modulation frequency fₘ by the modulator 11a. In FIG. 6, a peak 61 is an intensity peak of the interference waveform of the light beam in the mode 1, and a peak 62 is an intensity peak of the interference waveform of the light beam in the mode 2. A time difference between the peak 61 and the peak 62 is a difference in arrival time at which the light beam in each mode reaches the other end of the optical fiber to be measured 51, and becomes a DMD. In addition, since the interference waveform is measured by the image sensor, the electric field distribution when the peak of the intensity is observed can also be acquired. As a result, it is possible to determine which mode the peak is in.

That is, the arithmetic unit 16 captures the peak of the interference waveform observed by the image sensor 15 while changing the modulation frequency fₘ, determines the mode in which each peak is generated from the electric field distribution of the interference light beam when the peak is generated, and sets the time between the peaks as each DMD.

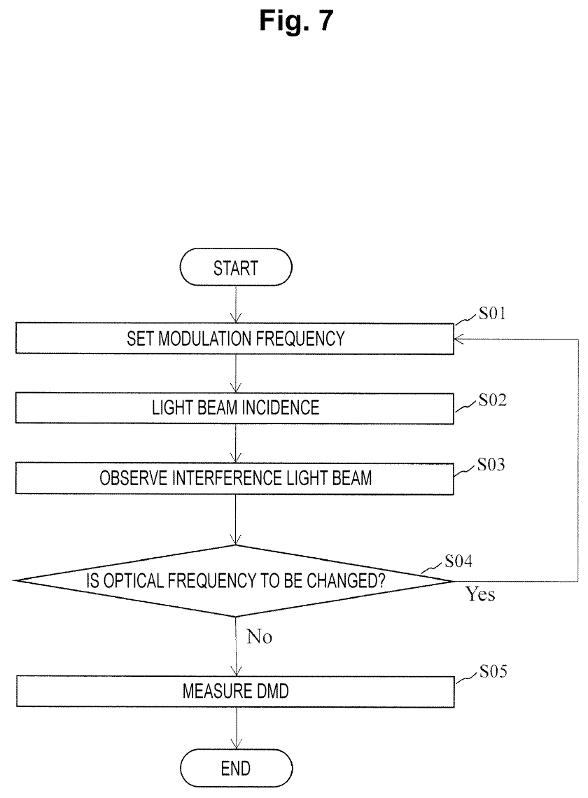

FIG. 7 is a flowchart illustrating a differential mode delay measuring method performed by the differential mode delay measurement device 301.

The differential mode delay measurement device 301 performs:
setting a modulation period for changing an optical frequency of a coherent light beam for the light source 10 (step S01);
bifurcating the light beam, exciting one of the light beams in a plurality of modes, causing the one of the light beams to enter one end of the optical fiber to be measured 51 that is an FMF, and inputting the other of the light beams into one end of the reference optical fiber 52 in a single mode (step S02);
observing, by the image sensor 15, an interference light beam between a measurement light beam emitted from the other end of the optical fiber to be measured 51 and a reference light beam emitted from the other end of the reference optical fiber 52 (step S03); and
detecting a peak of the interference light beam appearing when the modulation period is changed, measuring a group delay difference based on a difference in the modulation period in which the peak appears, and determining a type of the mode from an electric field distribution of the interference light beam at the peak (step S05).

In step S01, the optical frequency of the light beam output from the light source 11 is periodically changed using the modulator 11a. This period is the modulation frequency.

In step S02, the light beams from the light source 11 bifurcated by the branching element 12 are incident on the optical fiber to be measured 51 and the reference optical fiber 52, respectively. Here, the light beam incident on the optical fiber to be measured 51 is excited by the exciter 13a to each mode in which the light beam can be propagated through the optical fiber to be measured 51. The other light beam is incident on the reference optical fiber 52 from the light incidence means 13b in the unchanged single mode.

In step S03, the interference light beam between the light beam propagated through the optical fiber to be measured 51 and the light beam propagated through the reference optical fiber 52 is observed by the image sensor 15.

In step S04, it is determined whether to change the optical frequency. In the case where the optical frequency has not been changed to a predetermined range (“No” in step S04), the processing returns to step S01, the optical frequency is changed, and the processing up to step S03 is repeated. In the case where the optical frequency has been changed to the predetermined range (“Yes” in step S04), step S05 is performed.

In step S05, the arithmetic unit 16 detects a plurality of DC component peaks of the interference light beam from a result of observing the interference light beam while changing the optical frequency. The arithmetic unit 16 determines which mode the peak is in from the electric field distribution of the interference light beam when the peak is generated. Then, the arithmetic unit 16 measures the time between the peaks as each DMD.

Note that the differential mode delay measurement device 301 can perform steps S01 to S05 by controlling each component (the modulator 11a or the arithmetic unit 16) by a control unit (not illustrated in FIG. 1).

As described above, since the differential mode delay measurement device 301 measures the interference waveform of the light beam in which the optical frequency is periodically modulated by the image sensor, it is possible to easily measure the group delay time and the DMD of each mode with a simple configuration even for an optical fiber to be measured having a length of several hundred meters or more.

### REFERENCE SIGNS LIST

11 Light source
11a Modulator
12 Branching element
13 Light incidence unit
13a Exciter
13b Light incidence means
14 Multiplexing element
15 Image sensor
16 Arithmetic unit
17 Collimator
51 Optical fiber to be measured
52 Reference optical fiber
301 Differential mode delay measurement device

1. A differential mode delay measurement device comprising:
a light source configured to output a coherent light beam having an optical frequency changed with a predetermined modulation period;
a branching element configured to bifurcate the light beam;
a light incidence unit configured to excite one of the light beams in a plurality of modes, cause the one of the light beams to enter one end of an optical fiber to be measured that is a few-mode optical fiber, and input the other of the light beams into one end of a reference optical fiber in a single mode;
an image sensor configured to observe an interference light beam between a measurement light beam emitted from the other end of the optical fiber to be measured and a reference light beam emitted from the other end of the reference optical fiber; and
an arithmetic unit configured to detect a peak of the interference light beam appearing when the modulation period is changed, measure a group delay difference based on a difference in the modulation period in which the peak has appeared, and determine a type of the mode from an electric field distribution of the interference light beam at the peak.

2. The differential mode delay measurement device according to claim 1, wherein the image sensor operates at a sampling rate slower than the modulation period.

3. A differential mode delay measuring method comprising:
setting a modulation period for changing an optical frequency of a coherent light beam;
bifurcating the light beam;
exciting one of the light beams in a plurality of modes, causing the one of the light beams to enter one end of an optical fiber to be measured that is a few-mode optical fiber, and inputting the other of the light beams into one end of a reference optical fiber in a single mode;
observing, by an image sensor, an interference light beam between a measurement light beam emitted from the other end of the optical fiber to be measured and a reference light beam emitted from the other end of the reference optical fiber; and
detecting a peak of the interference light beam appearing when the modulation period is changed, measuring a group delay difference based on a difference in the modulation period in which the peak has appeared, and determining a type of the mode from an electric field distribution of the interference light beam at the peak.

4. The differential mode delay measuring method according to claim 3, wherein a sampling rate of the image sensor is slower than the modulation period.
